(19) United States
(12) Patent Application Publication
(10) Pub. No.: US 2022/0382016 A1
(43) Pub. Date: Dec. 1, 2022

(54) WEB CAMERA LENS ASSEMBLY

(71) Applicant: Logitech Europe S.A., Lausanne (CH)

(72) Inventors: Ting Chia Hsu, Hsinchu City (TW); Chang Chih Chen, Taichung City (TW); Ying-Hsiu Lin, New Taipei City (TW)

(21) Appl. No.: 17/331,335

(22) Filed: May 26, 2021

(51) Int. Cl. G02B 13/00; G02B 5/20

(52) U.S. Cl. CPC G02B 13/004; G02B 5/208

(57) ABSTRACT

A four piece lens assembly with a low profile is provided. The lens assembly has a sufficient FOV for personal use and has a small Chief Ray Angle (CRA) allowing the use of a small CRA image sensor. A static lens system is disclosed and includes, in one embodiment, a lens assembly housing with an aperture stop followed by a lens assembly with first-fourth lens elements. The fourth lens element is the closest lens element to an imaging sensor. The four lens elements are all plastic. The first, second and fourth lens elements have a positive focal length. The third lens element has a negative focal length. Both lens surfaces of each of the lens elements are aspherical.

### BACKGROUND

Lens systems with multiple lens elements are well known for cameras. For a static lens, obtaining a sufficient field of view (FOV) can be challenging because of the resulting distortion. Modern consumer electronic devices also have small form factors, making it desirable to have cameras which do not take up much room on the device. Also, in order to obtain precise curvatures for a lens design, glass lens elements are used, since they can be manufactured to more precise tolerances than plastic, even though they cost more than plastic.

A steep angle of entry for the light to the image sensor is usually required for sensors used in mobile phones, because lens thickness is often 3 mm or less.

It is desirable to have an inexpensive, static lens system with a relatively wide FOV and minimal distortion and aberrations, which can be used for a webcam or other personal use.

### SUMMARY

This disclosure describes various embodiments that relate to compact static lens assemblies. A four piece lens assembly with a low profile is provided. The lens assembly has a sufficient FOV for personal use (e.g., 50-70° for a webcam), and has a small Chief Ray Angle (CRA, <15°) allowing the use of a small CRA image sensor.

A static lens system is disclosed and includes, in one embodiment, a lens assembly housing with an aperture stop followed by a lens assembly with first-fourth lens elements. The fourth lens element is the closest lens element to an imaging sensor. The four lens elements are all plastic. The first, second and fourth lens elements have a positive focal length. The third lens element has a negative focal length. Both lens surfaces of each of the lens elements are aspherical.

In one embodiment, an IR filter is provided between the fourth lens element and the imaging sensor. The second and third lens elements have curvatures that reduce color aberrations. The fourth lens element has curvatures configured to redirect light to provide an image on the imaging sensor. Primarily the fourth lens element, but in combination with the whole lens assembly, produces a Chief Ray Angle (CRA) of less than 10°, allowing the use of low cost CMOS image sensors.

In one embodiment, a distance from the aperture stop to the imaging sensor is between 5.75-7.75 mm. A ratio of an overall focal length of the first through fourth lens elements (f) to a focal length of the first lens element (f1), plus a ratio of an overall focal length of the first through fourth lens elements (f) to a focal length of the second lens element (f2) is between 1.4 and 2.0 (1.4<f/f1+f/f2<2.0). An Abbe number of the fourth lens element (Vd4) and an Abbe number of the third lens element (Vd3) is between 25 and 45 (25<Vd4-Vd3<45).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure will be readily understood by the following detailed description in conjunction with the accompanying drawings, wherein like reference numerals designate like structural elements, and in which:

FIG. 1A shows a perspective view of an exemplary camera module suitable for use with the described embodiments;

FIG. 1B shows a perspective view of an alternate embodiment camera module suitable for use with the described embodiments;

FIG. 2 shows a cross-sectional view of lens elements making up a lens assembly according to an embodiment;

FIG. 3 shows a cross-section view of a lens assembly that illustrates how the lens elements are positioned within a lens housing according to an embodiment;

FIGS. 4A-B shows sagittal (S) and tangential (T) field curvature lines representing change in field curvature across a field of view of a lens assembly; and

FIG. 5 shows sagittal and tangential field curvature lines representing change in field curvature across a field of view of the lens assembly depicted in FIG. 2.

### DETAILED DESCRIPTION

Aspects of the present disclosure relate generally to optics for imaging devices, and in particular to optics suitable for use with videoconferencing devices, according to certain embodiments.

In the following description, various embodiments of a small form-factor imaging device will be described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

Embodiments of the invention provide a fixed lens system (no mechanical zoom). An inexpensive lens system ideal for a webcam is described. It has only four lens elements with a low profile (e.g., 6-7 mm) with a sufficient FOV for personal use and a small CRA allowing the use of a CMOS image sensor. The design provides a range of tolerances for each lens, allowing them to be manufactured from plastic (lighter and less expensive). Also, the design enables a relatively shallow angle of entry for the light to the image sensor. This allows the use of CMOS sensors usually designed for security cameras, which have very good low light performance. Note a steep angle is usually required for sensors used in cell phones, because lens thickness is often 3 mm or less.

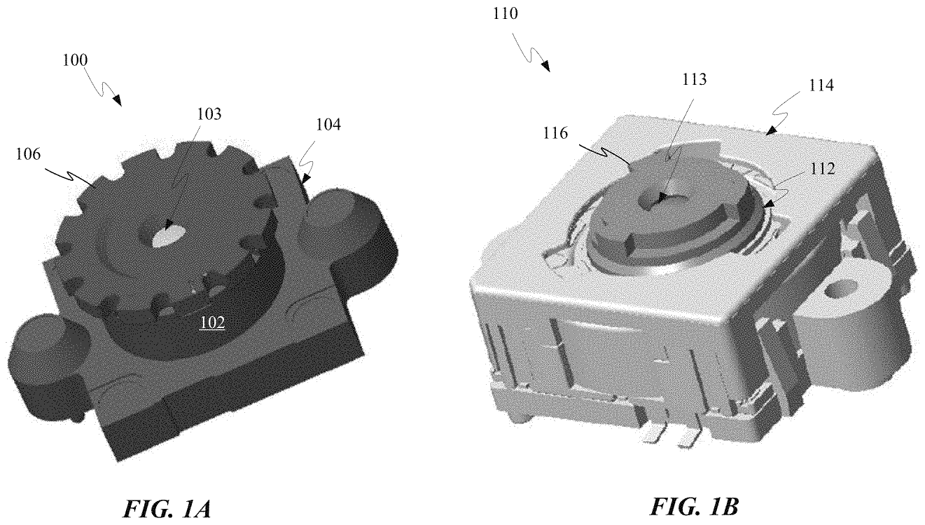

These and other embodiments are discussed below with reference to FIGS. 1-6; however, those skilled in the art will readily appreciate that the detailed description given herein with respect to these figures is for explanatory purposes only and should not be construed as limiting.

FIG. 1A shows a perspective view of an exemplary camera module 100 suitable for use with the described embodiments. Camera module 100 includes a lens housing 102 enclosing a lens assembly 103 and mounted on a base 104. A cylindrical ring 106 with knobs can be rotated for assembly during manufacturing to achieve the proper distance of the lens system to image sensor. The components of module 100 can be formed from metal or polymeric materials. A protective cover can be sealed over lens assembly 103 to prevent moisture from intruding into an interior volume defined by lens housing 102. The protective cover can have a negligible amount of magnification and be optically clear to allow the lens assembly 103 within lens housing 102 to operate without substantial degradation.

FIG. 1B shows a perspective view of an alternate embodiment camera module 110 suitable for use with the described embodiments. Camera module 110 includes a lens housing 112 enclosing a lens assembly 113 and mounted on a base 114. A cylindrical ring 116 with knobs can be rotated for assembly during manufacturing to achieve the proper distance of the lens system to image sensor. The components of module 110 can be formed from metal or polymeric materials. A protective cover can be sealed over lens assembly 113 to prevent moisture from intruding into an interior volume defined by lens housing 112.

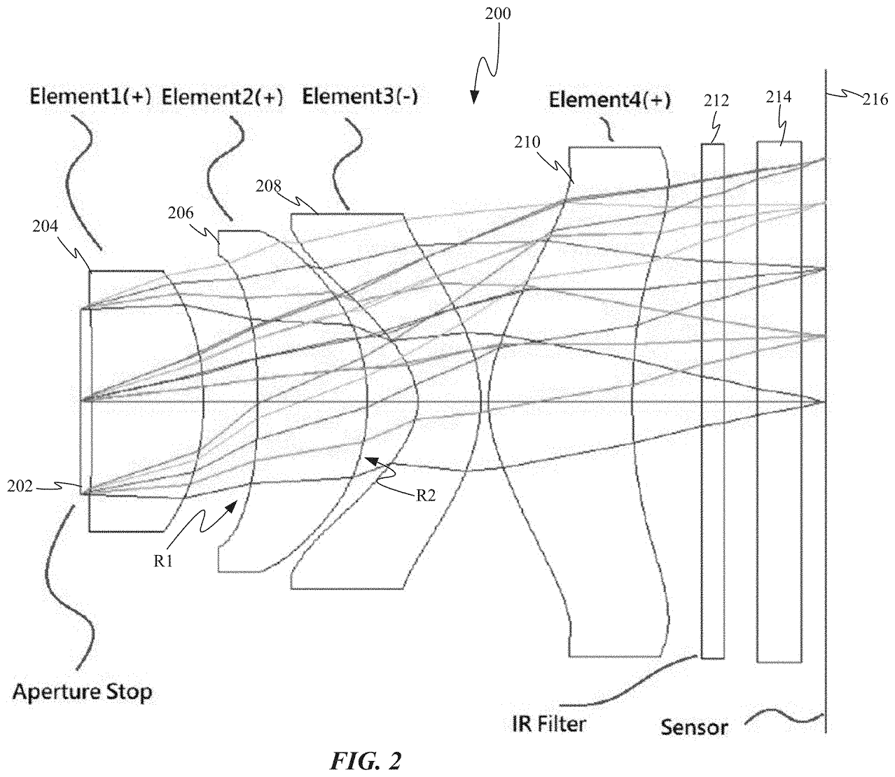

FIG. 2 shows a cross-sectional view of lens elements making up a lens assembly 200. The different colored lines show the different incident angles of light and show the ray tracing in the system. FIG. 2 shows the lens elements positioned to minimize an overall focal length of lens assembly 200. Lens assembly 200 is made up of from front to back lens elements 1-4. The lens elements are 204, 206, 208 and 210. The lens elements form a (+) (+) (−) (+) arrangement of positive and negative focal length elements. The lens elements in one embodiment are all made of plastic, to reduce manufacturing costs. The lens assembly is designed with sufficient tolerances to allow for variations in the manufacturing of the plastic lens elements.

Lens element 204 collects the light, and lens elements 206 and 208 are used to reduce color aberration. Color or chromatic aberration from earlier lens elements cause different wavelengths of light (different colors) to have differing focal lengths. Lens element 210 is an achromatic lens that brings different colors (in particular red and blue) to the same focus. Alternately, other lens shapes could be used to correct the chromatic aberrations. Lens 210 focuses a received image on image sensor 216. Fourth lens element 210 is converts a received light cone into image plane and provides good focus. Fourth lens element 210 also insures that the image fits within a small Chief Ray Angle (CRA) specified for the image sensor.

A chief ray is the ray from an off-axis object point which passes through the center of the aperture stop. The chief ray enters along a line directed towards the midpoint of the entrance pupil, and leaves the system along a line passing through the center of the exit pupil. CMOS image sensors, which are less expensive than other image sensors, typically have a small CRA (less than 15 degrees). Thus, for a low cost design, the lens assembly needs to provide a CRA that is small, such as less than 15 degrees. The fourth lens element 210 is the main determinant of the CRA of the lens assembly, producing a CRA of less than 15 degrees.

At the back of the lens group is an IR filter 212, and glass cover 214 of sensor and a sensor 216. The IR filter is an infrared light blocking element or coating preventing most infrared light from reaching digital sensor 216. In some embodiments, the infrared coating can block 98-99% of light having a wavelength between 700 nm and 1000 nm. This IR filter can prevent degraded image capture performance caused by IR light being incorrectly captured and presumed to be visible light. An IR filter coating could also take other forms such as a film layer adhered to one side of the sensor's glass cover 214.

Table (1) depicted below shows various other exemplary technical features of lens assembly 200 depicted in FIG. 2. It should be noted that other designs, materials and other technical features may vary and the below technical specifications should not be construed as limiting.

TABLE 1
Unit: mm
Focal Length 3.45
Image sensor Size: Image height = 2.2 mm (radius)
Lens Image circle: 4.8 mm (Diameter)

| | | | Conic | Conic | | | Focal | | Distance to |
|---|---|---|---|---|---|---|---|---|---|
| Element | R1 | R2 | (R1) | (R2) | Material | Index | Length | Distance | image sensor |
| 0 | Aperture Stop | | | | | | | | |
| | | | | | (Air Gap) | | | 0.28 | 6.76 |
| 1 | 22.5 | −2.5 | −50 | −0.2 | Plastic | 1.55 | 4.4 | 0.82 | 6.48 |
| | | | | | (Air Gap) | | | 0.5 | |
| 2 | −5 | −1.8 | 8.6 | −0.65 | Plastic | 1.55 | 4.34 | 0.99 | 5.16 |
| | | | | | (Air Gap) | | | 0.44 | |
| 3 | −0.5 | −1.7 | −2.2 | −0.4 | Plastic | 1.63 | −1.7 | 0.56 | 3.73 |
| | | | | | (Air Gap) | | | 0.07 | |
| 4 | 1 | 5.4 | −5.1 | 3.6 | Plastic | 1.55 | 2.2 | 1.33 | 3.1 |
| | | | | | (Air Gap) | | | 0.74 | |
| 5 | ∞ | ∞ | | | Glass (IR Cut) | 1.517 | 100000 | 0.2 | 1.03 |
| | | | | | (Air Gap) | | | 0.3 | |
| | | | | | Glass (Sensor Top Cover) | | | 0.4 | |
| | | | | | (Air Gap) | | | 0.13 | |
| | | | | | Sensor | | | | 0 |
| | | | | | Total Track | | | 6.76 | |

Table (1) shows preferred characteristics of each of lens elements 1-4, plus aperture stop 202 (element 0) and IR filter 212 (element 5). The columns for R1 and R2 set forth the radius of the spherical contribution to the curve of the center portion of each lens element, with R1 corresponding to the curvature of the front surface and R2 corresponding to the back surface, as illustrated in FIG. 2 for lens element 206, element 2. Conic (R1) and conic (R2) set forth the radius of the conical contribution to the curve of the center portion of each lens element, with R1 corresponding to the curvature of the front surface and R2 corresponding to the back surface.

The lens material is shown for each element, along with the intermediate air gaps. An index of refraction of the lens material is then shown. Next, the focal length of each lens element (in millimeters) is shown. Next, the distance from the previous element or width of a lens element is shown. If the material is “air gap”, then the distance from the previous lens element is shown. If the material shows “plastic” or “glass”, then it is the width of the lens or other element. The last column shows the distance of each element to the image sensor, in mm. In one embodiment, the total focal length is 3-4 mm, with a total distance, or “length” of the lens assembly being 6-7 mm. In the embodiment shown in Table 1, the numbers provided account for a total focal length of 3.45 mm, with a total distance, or depth of the lens assembly, being 6.76 mm.

In the embodiment shown in Table 1, the index of refraction of the lens material for lens elements 1, 2 and 4 are the same. The focal lengths of the first and second lens elements is similar, at 4.4 mm and 4.34 mm, respectively.

In the novel design of the present invention, the focal lengths, curvatures and other aspects of the lens assembly may have manufacturing variations due to the nature of plastic (which is more difficult to manufacture to exact specifications than more expensive glass). The design allows such variations within a range while still providing good results. In one embodiment, a change in the value of one element within the acceptable range can be compensated for by changes in the value of one or more other elements, within their ranges. Such acceptable ranges are set forth in the equations below in Table (2).

TABLE 2

| | | Rel | |
|---|---|---|---|
| | Acceptance range: | Value | Description |
| 1 | −15 < R11/R12 < −8 | −9.0 | (1st lens R1)/(1st lens R2) |
| 2 | 1.4 < f/f1 + f/f2 < 2 | 1.58 | (Total f)/(1st lens f1) + (Total f)/ |
| | | | (1st lens f2) |
| 3 | 0.25 < R31/R32 < 0.5 | 0.29 | (3rd lens R1)/(3rd lens R2) |
| 4 | 25 < Vd4 − Vd3 < 40 | 32 | (4th lens material Vd) − (3rd lens |
| | | | material Vd) |
| 5 | 0.25 < CT2/f < 0.35 | 0.29 | (2nd lens center thickness/ |
| | | | (Total f) |
| 6 | 2.7 < TTL/MaxIH < 3.3 | 2.79 | (Total length)/ |
| | | | (Maximum image height) |

The following acronyms are used in Table (2):
R1 and R2: Radius of curvature of the spherical contribution to the curve of the center portion of each lens element, with R1 corresponding to the curvature of the front surface and R2 corresponding to the back surface.
f: focal length.
Vd: Abbe number (color dispersion specification of optical material)
CT: Center Thickness of the lens.
TTL: Total Length, from the 1^{st} component to the image sensor.
MaxIH: Maximum image height.

The Abbe number, also known as the V-number or constringence of a transparent material, is a measure of the material's dispersion (variation of refractive index versus wavelength). High values of V indicate low dispersion. Higher Abbe values indicate less chromatic aberration.

As shown in FIG. 2, a number of features have an acceptable range, or tolerance, while still providing sufficient quality for webcam usage with plastic lenses. As shown in row 1, the ratio of the radius of the inside and outside spherical curvature portion of lens element 1 can vary from −8 to −15. As shown in row 2, the ratio of the total focal length to the lens element 1's focal length, plus the ratio of the total focal length to the lens element 2's focal length can vary from 1.4 to 2. As set forth in row 3, the ratio of the inside and outside spherical curvature portion radius of lens element 3 can vary from 0.25 to 0.5.

As shown in row 4, the difference between the Abbe number (Vd) of lens element 4 and lens element 3 can vary between 25 and 40. Row 5 sets forth that the ration of the center thickness of lens element 2 to the total focal length can range from 0.25 to 0.35. As set forth in row 6, the ratio of the total length of the lens assembly to the maximum image height can vary from 2.7 to 3.3.

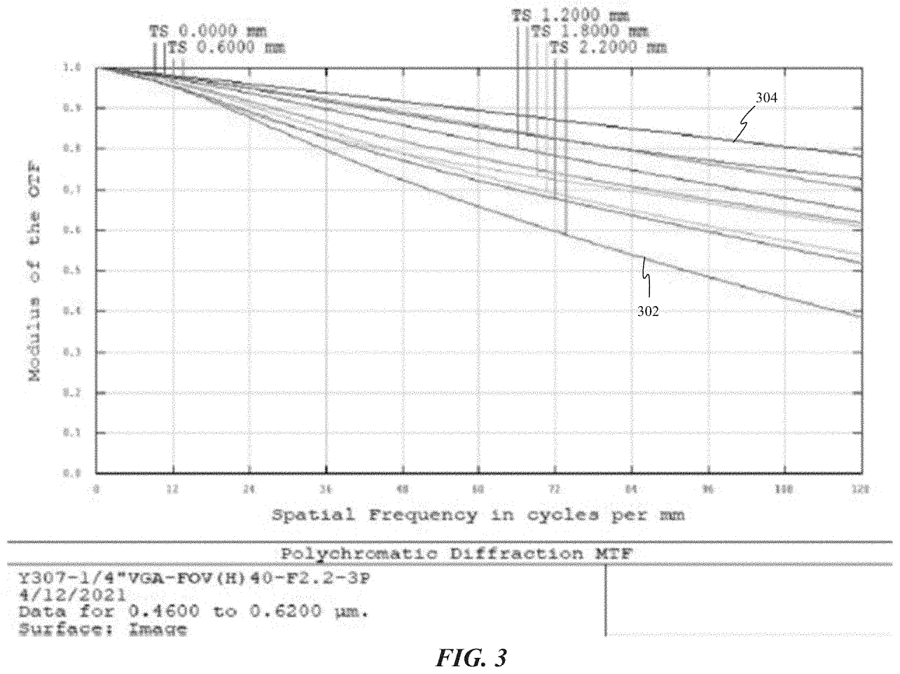

FIG. 3 shows modulation transfer functions (MTF) charts for the focal lengths of lens assembly 200. MTF is the spatial frequency response of an imaging system or element. It is the contrast at a given spatial frequency relative to low frequencies. MTF is a useful measure of true or effective resolution, since it accounts for the amount of blur and contrast over a range of spatial frequencies. FIG. 3 shows the modulus of the Optical Transfer Function (OTF) versus spacial frequency. These curves illustrate the high resolution capabilities of lens assembly 200. The curves shown range from curve 302 (2.2000 mm—Tangential) to curve 304 (differential limit 0.0000 mm—tangential). In FIG. 3, S means Sagittal, and T means Tangential. The term “tangential” refers to data computed in the tangential plane, which is the plane defined by a line and one point: the line is the axis of symmetry, and the point is the field point in object space. The sagittal plane is the plane orthogonal to the tangential plane, which also intersects the axis of symmetry at the entrance pupil position. FIG. 3 shows the MTF data, that is the major indicator for the optical performance. The design curve shows good performance to meet the requirements of a high resolution sensor. For typical rotationally symmetric systems with field points lying along the Y axis, the tangential plane is the YZ plane and the sagittal plane is the plane orthogonal to the YZ plane which intersects the center of the entrance pupil.

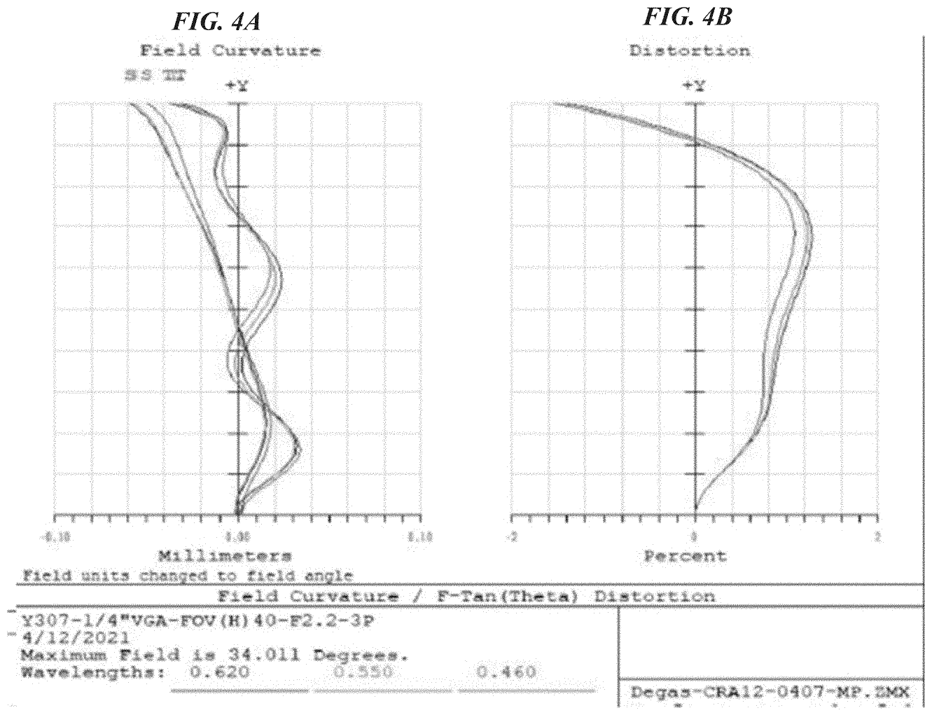

FIGS. 4A-B shows sagittal (S) and tangential (T) field curvature lines representing change in field curvature across a field of view of lens assembly 200. FIG. 4A plots the field curvature for different colors, as shown on a plot of degrees versus mm. FIG. 4A shows curves corresponding to the colors shown in FIG. 3., in particular the blue (0.620), green (0.550) and red (0.460) wavelengths. FIG. 4B shows degrees versus percentage of F-Theta distortion. Distortion of less than 2% is provided by the lens assembly. The field curvature plot shows the distance from the image surface to the paraxial image surface as a function of the field coordinates. The tangential data are the distances measured along the Z-axis from the image surface to the paraxial image surface measured in the tangential (YZ) plane. The sagittal data are the distances measured in the plane orthogonal to the tangential plane. The base of the plot is on axis, and the top of the plot represents the maximum field (angle or height). There are no units on the vertical scale because the plot is normalized to the maximum field coordinate along the scan direction.

Embodiments of the present invention provide a camera system 100 with a lens assembly housing 102 defining a front opening. An imaging sensor 216 is provided. A lens assembly 200 is disposed within the lens assembly housing and comprises first (204), second (206), third (208) and fourth (210) lens elements, the fourth lens element being a closest lens element to the imaging sensor and the first lens element being adjacent to the front opening. An aperture stop 202 is in front of the lens assembly. A glass IR filter 212 is between the fourth lens element and the imaging sensor. The first, second, third and fourth lens elements are plastic. The first, second and fourth lens elements have a positive focal length. The third lens elements has a negative focal length. Both lens surfaces of each of the first, second, third and fourth lens elements are aspherical. The first lens element collects light with a field of view between 50-70 degrees. The second and third lens elements have curvatures configured to reduce color aberrations. The fourth lens element has curvatures configured to redirect light to provide an image on the imaging sensor. A ratio of an overall focal length of the first through fourth lens elements (f) to a focal length of the first lens element (f1), plus a ratio of an overall focal length of the first through fourth lens elements (f) to a focal length of the second lens element (f2) is between 1.4 and 2.0 (1.4<f/f1+f/f2<2.0). The distance from the aperture stop to the imaging sensor is between 5.75-7.75 mm. The total focal length of the lens assembly is between 3-4 mm.

### Examples of Systems for Operating WebCam Devices

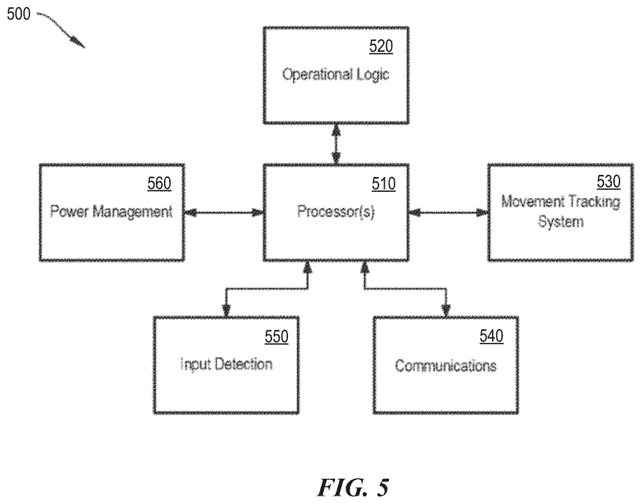

FIG. 5 is a simplified block diagram of a system 500 configured to control camera module 100, according to certain embodiments. In this embodiment, camera module 100 is as a webcam, that can be used, for example, in a video conferencing system. System 500 includes processor(s) 510, operational logic 520, movement tracking system 530, input detection system 550, and power management system 560. Each of system blocks 520-560 can be in electrical communication with the processor(s) 510. System 500 may further include additional systems that are not shown or discussed to prevent obfuscation of the novel features described herein.

In certain embodiments, processor(s) 510 can include one or more microprocessors (μCs) and can be configured to control the operation of system 500. Alternatively, processor(s) 510 may include one or more microcontrollers (MCUs), digital signal processors (DSPs), or the like, with supporting hardware and/or firmware (e.g., memory, programmable I/Os, etc.), as would be appreciated by one of ordinary skill in the art. In some embodiments, multiple processors may provide an increased performance in system 500 speed and bandwidth. It should be noted that although multiple processors may improve system 500 performance, they are not required for standard operation of the embodiments described herein.

Operational logic 520 can include any combination of software, firmware, or hardware that can perform the various steps, operations, and functions associated with system 100, as described above with respect to FIGS. 1-4B. For instance, operational logic 520 can control settings and operating parameters such as recording resolution, focus, magnification and lens assembly azimuth and inclination. Operational logic 520 can be stored in any suitable non-transitory computer-readable storage media that can store program code and/or data that provide the functionality of embodiments of the present disclosure. That is, operational logic 520 can store one or more software programs to be executed by processors (e.g., in processor(s) 510). It should be understood that “software” can refer to sequences of instructions that, when executed by processing unit(s) (e.g., processors, processing devices, etc.), cause system 500 to perform certain operations of software programs. The instructions can be stored as firmware residing in read only memory (ROM) and/or applications stored in media storage that can be read into memory for processing by processing devices. Software can be implemented as a single program or a collection of separate programs and can be stored in non-volatile storage and copied in whole or in-part to volatile working memory during program execution. From a storage subsystem, processing devices can retrieve program instructions to execute in order to execute various operations described herein. In some embodiments, the memory associated with operational logic 520 can include RAM, ROM, solid-state memory, magnetic or optically-based memory systems, removable media (e.g., “thumb drives,” SD cards, flash-based devices), or other types of storage media known in the art. One of ordinary skill in the art would understand the many variations, modifications, and alternative embodiments thereof.

Movement tracking system 530 can be configured to track a movement of participants in a videoconferencing session. In certain embodiments, one or more optical or auditory sensors can be used for movement and active speaker determination. Optical sensors can take the form of infrared sensors for tracking movement toward and away from the videoconferencing device and auditory sensors can take the form of one or more directional microphones for identifying an active speaker. For example, movement tracking system 530 can provide movement data to a host computer to control magnification and orientation of an imaging device. Movement tracking system 530 can report movement information to processor(s) 510.

Communications system 540 can be configured to provide wireless communication between videoconferencing system 100 and a host computing device, according to certain embodiments. Communications system 540 can employ any suitable wireless communication protocol including, but not limited to Bluetooth®-based communication protocols (e.g., BLE), IR, ZigBee®, ZWire®, Wi-Fi (IEEE 802.11), Thread, Logi® protocols, or other suitable communication technology to facilitate wireless bidirectional communication between videoconferencing system 100 and a host computing device. System 500 may optionally comprise a hardwired connection to a host computing device. For example, videoconferencing device 100 can be configured to receive a Universal Serial Bus (e.g., USB-C) cable to enable bi-directional electronic communication between videoconferencing device 100 and a host computing device. Some embodiments may utilize different types of cables or connection protocol standards to establish hardwired communication with other entities.

Input detection system 550 can be configured to detect a touch or touch gesture on one or more buttons, touch sensitive surfaces, or the like, on videoconferencing system 100. Input detection system 550 can include one or more touch sensitive surfaces, touch sensors, buttons, controls, or other user interface, as would be understood by one of ordinary skill in the art. Touch sensors generally comprise sensing elements suitable to detect a signal such as direct contact, electromagnetic or electrostatic fields, or a beam of electromagnetic radiation. Touch sensors can be configured to detect at least one of changes in the received signal, the presence of a signal, or the absence of a signal.

Power management system 560 can be configured to manage power distribution, recharging, power efficiency, and the like, for videoconferencing 100. In some embodiments, power management system 560 can include a battery (not shown), a USB based recharging system for the battery (not shown), power management devices, and a power grid within system 500 to provide power to each subsystem (e.g., accelerometers, gyroscopes, etc.). In certain embodiments, the functions provided by power management system 560 may be incorporated into processor(s) 510. The power source can be a replaceable battery, a rechargeable energy storage device (e.g., super capacitor, Lithium Polymer Battery, NiMH, NiCd), or a corded power supply (e.g., via USB-C port—see FIG. 1). One of ordinary skill in the art would understand the many variations, modifications, and alternative embodiments thereof.

It should be appreciated that system 500 is illustrative and that variations and modifications are possible. System 500 can have other capabilities not specifically described here (e.g., mobile phone, global positioning system (GPS), power management, one or more cameras, various connection ports for connecting external devices or accessories, etc.). Further, while system 500 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatuses including electronic devices implemented using any combination of circuitry and software. Furthermore, aspects and/or portions of system 500 may be combined with or operated by other sub-systems as required by design. For example, operational logic 520 may operate within processor(s) 510 instead of functioning as a separate entity. The foregoing embodiments are not intended to be limiting and those of ordinary skill in the art with the benefit of this disclosure would appreciate the myriad applications and possibilities.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For example, the videoconferencing term should be construed broadly and could also refer to a webcam or action camera. Use of the described lens assembly with other imaging system types such as DSLRs, mirrorless and cinema cameras should also be deemed to be within the scope of contemplated use.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

What is claimed is:

1. A camera system, comprising:
a lens assembly housing defining a front opening;
an imaging sensor;
a lens assembly disposed within the lens assembly housing and comprising: first, second, third and fourth lens elements, the fourth lens element being a closest lens element to the imaging sensor and the first lens element being adjacent to the front opening;
an aperture stop in front of the lens assembly;
wherein the first, second, third and fourth lens elements are plastic;
wherein the first, second and fourth lens elements have a positive focal length;
wherein the third lens elements has a negative focal length;
wherein both lens surfaces of each of the first, second, third and fourth lens elements are aspherical;
wherein the first lens element collects light with a field of view between 50-70 degrees;
wherein the second and third lens elements have curvatures configured to reduce color aberrations; and
wherein the fourth lens element has curvatures configured to redirect light to provide an image on the imaging sensor.

2. The camera system as recited in claim 1:
wherein a ratio of an overall focal length of the first through fourth lens elements (f) to a focal length of the first lens element (f1), plus a ratio of an overall focal length of the first through fourth lens elements (f) to a focal length of the second lens element (f2) is between 1.4 and 2.0 (1.4<f/f1+f/f2<2.0).

3. The camera system as recited in claim 1, further comprising:
a glass IR filter between the fourth lens element and the imaging sensor.

4. The camera system as recited in claim 1, wherein a distance from the aperture stop to the imaging sensor is between 5.75-7.75 mm.

5. The camera system as recited in claim 4, wherein a distance from the aperture stop to the imaging sensor is between 6.25-7.25 mm.

6. The camera system as recited in claim 1, wherein a difference between an Abbe number of the fourth lens element (Vd4) and an Abbe number of the third lens element (Vd3) is between 25 and 45 (25<Vd4-Vd3<45).

7. The camera system as recited in claim 1, wherein a ratio of the thickness of the center of the second lens (CT2) to an overall focal length (f) of the lens assembly is between 0.25 and 0.35 (0.25<CT2/f<0.35).

8. The camera system as recited in claim 1, wherein a ratio of the total length of a distance from the aperture stop to the imaging sensor (TTL) to a maximum image height on the imaging sensor (MaxIH) is between 2.7 and 3.3 (2.7<TTL/MaxIH<3.3).

9. The camera system as recited in claim 1, wherein the fourth lens is configured to focus received images on the imaging sensor within the Chief Ray Angle (CRA) of the imaging sensor.

10. A camera system, comprising:
a lens assembly housing defining a front opening;
an imaging sensor;
a lens assembly disposed within the lens assembly housing and comprising: first, second, third and fourth lens elements, the fourth lens element being a closest lens element to the imaging sensor and the first lens element being adjacent to the front opening;
an aperture stop in front of the lens assembly;
a glass IR filter between the fourth lens element and the imaging sensor;
wherein the first, second, third and fourth lens elements are plastic;
wherein the first, second and fourth lens elements have a positive focal length;
wherein the third lens elements has a negative focal length;
wherein both lens surfaces of each of the first, second, third and fourth lens elements are aspherical;
wherein the first lens element collects light with a field of view between 50-70 degrees;
wherein the second and third lens elements have curvatures configured to reduce color aberrations;
wherein the fourth lens element has curvatures configured to redirect light to provide an image on the imaging sensor:
wherein a ratio of an overall focal length of the first through fourth lens elements (f) to a focal length of the first lens element (f1), plus a ratio of an overall focal length of the first through fourth lens elements (f) to a focal length of the second lens element (f2) is between 1.4 and 2.0 (1.4<f/f1+f/f2<2.0);
wherein a distance from the aperture stop to the imaging sensor is between 5.75-7.75 mm; and
wherein a total focal length of the lens assembly is between 3-4 mm.

11. The camera system as recited in claim 10, wherein a distance from the aperture stop to the imaging sensor is between 6.25-7.25 mm.

12. The camera system as recited in claim 7, wherein an image height on the imaging sensor is between 2-2.5 mm.

13. The camera system as recited in claim 7, wherein a difference between an Abbe number of the fourth lens element (Vd4) and an Abbe number of the third lens element (Vd3) is between 25 and 45 (25<Vd4-Vd3<45).

14. The camera system as recited in claim 7, wherein a ratio of the thickness of the center of the second lens (CT2) to an overall focal length (f) of the lens assembly is between 0.25 and 0.35 (0.25<CT2/f<0.35).

15. A camera system, comprising:
a lens assembly housing defining a front opening;
an imaging sensor;
a lens assembly disposed within the lens assembly housing and comprising: first, second, third and fourth lens elements, the fourth lens element being a closest lens element to the imaging sensor and the first lens element being adjacent to the front opening;
an aperture stop in front of the lens assembly;
wherein the first, second, third and fourth lens elements are plastic;
wherein the first, second and fourth lens elements have a positive focal length;
wherein the third lens element has a negative focal length; and
wherein both lens surfaces of each of the first, second, third and fourth lens elements are aspherical.

16. The camera system as recited in claim 15, wherein the first lens element collects light with a field of view between 50-70 degrees.

17. The camera system as recited in claim 15, further comprising:
an IR filter between the fourth lens element and the imaging sensor.

18. The camera system as recited in claim 15,
wherein the second and third lens elements have curvatures configured to reduce color aberrations; and
wherein the fourth lens element has curvatures configured to redirect light to provide an image on the imaging sensor.

19. The camera system as recited in claim 15, wherein a distance from the aperture stop to the imaging sensor is between 6.25-7.25 mm.

20. The camera system as recited in claim 15, wherein the fourth lens is configured to focus received images on the imaging sensor within the Chief Ray Angle (CRA) of the imaging sensor.
